(19) United States
(12) Patent Application Publication
(10) Pub. No.: US 2026/0205318 A1
(43) Pub. Date: Jul. 16, 2026

(54) METHOD AND CONFERENCE SYSTEM FOR CONDUCTING A VOTING

(71) Applicant: Robert Bosch GmbH, Stuttgart (DE)

(72) Inventors: Elien Vergeer, Hoornaar (NL); Sjack Schellekens, Tilburg (NL)

(21) Appl. No.: 19/138,645

(22) PCT Filed: Dec. 20, 2022
(86) PCT No.: PCT/EP2022/087009

§ 371 Date: Jun. 12, 2025

(51) Int. Cl. H04L 12/18; G06V 10/10; G06V 10/74

(52) U.S. Cl. CPC H04L 12/1831; G06V 10/10; G06V 10/74; H04L 12/1827

(57) ABSTRACT

The invention relates to a method for conducting a voting using a conference system, the conference system including at least a first conferencing unit having a camera and a screen (10), and a second conferencing unit having a screen, the method comprising the steps of receiving of a vote (6b) by means of an input (6a-6c) into the first conferencing unit; recording the vote (6b) by the first conferencing unit and capturing an image (lc) by the camera; sending the vote (6b) and the image (lc) to a second conferencing unit; verifying the content of image (1c) on the second conferencing unit by means of a reference; counting the vote (6b) if the image (1c) matches the reference; and discarding the vote (6b) if the image does not match the reference.

### BACKGROUND

The present invention relates to method for conducting a voting using a conference system as well as a conference system and a computer program for carrying out the method.

Electronic conference systems usually comprise a plurality of delegate units, each delegate unit providing a speaking place for a person attending a conference. Such delegate units can also enable voting, e.g., via push or touch buttons. For example, WO 2011/009483 A1 dis-closes a conference system comprising delegate units.

### SUMMARY

According to the invention a method for conducting a voting using a conference system as well as a conference system and a computer program for performing the method according to the independent claims are disclosed herewith. Further preferred developments are subject-matter of the dependent claims and the description below. The method comprises of verifying the content of image on the second conferencing unit by means of a reference, counting the vote if the image matches the reference; and discarding the vote if the image does not match the reference, especially by providing a user interface for verifying the content of image on the second conferencing unit by means of a reference, counting the vote if the image matches the reference; and discarding the vote if the image does not match the reference.

The conference system includes at least a first conferencing unit having a camera and a screen, and a second conferencing unit having a screen.

In an embodiment, the conferencing units, especially the second conferencing unit, are so-called delegate units of the conference system. The delegate units may provide a speaking place for a person attending a meeting/conference in person. In addition to the screen, each delegate unit may comprise a microphone and a loudspeaker. The microphone may be used to capture the statements or contributions to the discussion of the user of the delegate unit. The loudspeaker may be provided for outputting the contributions of other users of the conference system. The activation and deactivation of the microphones can be operated in several microphone management operation modes, e.g. by pushing a button provided on the delegate unit and/or by a release from a delegate unit assigned to a chairperson of a meeting/conference. Usually, multiple delegate units of a conference system are placed in the same room.

In an embodiment, the first conferencing unit is a video conferencing device. For example, the video conferencing device may be a mobile device such as a mobile phone (smart phone), tablet, or laptop. It is also possible that the video conferencing device is a delegate unit which is designed specifically for online (remote) conferencing by providing means enabling the delegate unit to be connected to the conference system via a network such as the internet. Usually, the video conferencing device is not placed in the same room as the delegate units of a conference system.

The invention allows for a participant attending a conference remotely, i.e. not using a regular delegate unit, but using a video conferencing device like a smart phone or personal computer as a first conferencing unit, and voting via the first conferencing unit in a secure way. I.e., the first conferencing unit is usually not placed in the same room as the second conferencing unit

The invention enables a documentation of a vote submitted online along with a visual identification of a participant casting the vote via a video conferencing device. This allows to identify if the person who casts the vote is actually the participant having permission to vote. The visual identification is done at the moment of casting the vote, and for each separate vote of an online participant. An online participant shall be understood to be a participant who takes part in a meeting/conference from a remote location via a network such as the internet.

According to an aspect of the invention, a vote of the online participant is received by means of an input into the first conferencing unit. The camera may, for example, be a webcam or any type of camera suitable for capturing and transmitting digital images.

The vote is recorded by the first conferencing unit, and an image (photo) of the online participant is captured by a camera pointed at the latter. Subsequently, the vote and the image of the online participant are sent to a second conferencing unit. In an embodiment, the second conferencing unit may be a delegate unit, e.g. assigned to a chairperson of a meeting/conference.

On the second conferencing unit the image of the online participant is verified by means of a reference. In this context, the image of the online participant received by the second conferencing unit can be displayed, for example, on a screen of the second conferencing unit. Based on the displayed image, the chairperson, for example, can verify the image by comparing it with a reference.

According to an embodiment, the reference may be a reference image of the online participant taken in advance of a conference and stored in a database. The database may be connected to the conference system via a network or may be included in the conference system. For example, the reference image may be submitted as part of a registration for the meeting/conference and stored in the database. Depending on consent of the online participant, the image may be deleted from the database at the end of the meeting/conference or may be stored permanently therein. The latter avoids the need to provide a reference image of the online participant before each meeting if meetings are held regularly and with the same participants. In terms of smaller meetings, it may be also possible that the chairperson knows the registered participants personally and is able to identify the online participant without the need of a reference image.

Alternatively or in addition, the comparison of the image of the online participant received by the second conferencing unit with the reference image can be performed automatically by the conference system, for example, by using a suitable image processing algorithm. For example, the comparison of the captured image and the reference image may be carried out using artificial intelligence (AI). In this context, machine learning, e.g. by using a state vector machine, and neural networks for deep learning can be used. The respective AI models can be trained with the reference images of the online participants stored in the database.

If the image of the online participant received by the second conferencing unit matches the reference, the vote of the online participant is counted. However, if the received image does not match the reference, the vote of the online participant is discarded. This ensures that only people who are authorized to vote are considered in a voting conducted during an online or hybrid meeting.

According to an embodiment, a trigger signal may be sent from the second conferencing unit to the first conferencing unit. When receiving the trigger signal, the camera pointed at the online participant may be automatically enabled (activated) by the first conferencing unit. This ensures that the camera is ready for operation when the online participant cast his vote. The image of the online participant can then be captured by the camera when the first conferencing unit receives the vote of the online participant.

Additionally or alternatively, the camera may be automatically enabled in the way described above when presence of participants of the online meeting is verified. This allows using the camera for two items on an agenda of a meeting, namely to verify the presence of the online participant and to verify his vote. It may be also possible that the camera is enabled manually by the online participant either when the voting is opened or when the presence of the participants is verified.

In an embodiment, a life camera image of the online participant is transmitted to the second conferencing unit when the camera is enabled. In other words, a life camera image of the online participant is provided, e.g., to the chairperson of the meeting/conference, at least before the image of the online participant is captured, so that the chairperson can additionally match the captured image with the life camera image provided before the vote. In an embodiment, the transmission can end, when the image of the online participant is captured. It may also be possible, that the camera remains activated after the image has been captured, e.g., during an entire meeting/conference.

In an embodiment, the image of the online participant is captured at the moment when the vote is received by the first conferencing unit and/or a predetermined time after the vote is received by the first conferencing unit. This allows the participant's image capturing to be synchronized with the voting process.

In an embodiment, the image and the vote of the online participant may be displayed together on a screen of the first conferencing unit. This allows for the participant to see and verify the data that are transferred to the second conferencing unit.

In an embodiment, the image and the vote of the online participant may be joined in a single electronic file. In this way, the online participant's vote and image can be combined into one electronic file and sent together to the second conferencing unit and/or to other devices.

In an embodiment, the electronic file may be a report of the meeting/conference in which the voting was conducted. It may be also possible that the image and the vote of the online participant are stored in a separate electronic file from the meeting report or that they are removed after the vote has been verified.

In an embodiment, a new image of the online participant may be captured when the vote already received by the first conferencing unit changes due to a new input from the online participant. In other words, if the online participant changes his vote, a new image of the online participant is captured, to verify that the changed vote has actually been cast by the online participant. This ensures that each vote cast by the online participant can be verified by an associated image of the participant.

The implementation of a method according to the invention in the form of a computer program or computer program product with program code for carrying out all method steps is also advantageous, since this causes particularly low costs, especially if an executing control unit is still used for further tasks and is therefore present anyway. Finally, a machine-readable storage medium is provided with a computer program stored thereon as described above. Suitable storage media or data carriers for providing the computer program are, in particular, magnetic, optical and electrical memories, such as hard disks, flash memories, EEPROMs, DVDs and the like. It is also possible to download a program via computer networks (Internet, intranet, etc.).

Such a download can take place wired or wirelessly (e.g. via a WLAN network, a 3G, 4G, 5G or 6G connection, etc.).

### BRIEF DESCRIPTION OF THE DRAWINGS

Further advantages and embodiments of the invention are shown in the following description and the accompanying figures. The invention is illustrated schematically by means of examples in the figures and is described below with reference to the figures. The same elements are provided with the same reference signs so that a repeated description is dispensed if not needed.

FIG. 1 shows a flow chart illustrating an example of a method according to the present invention.

FIGS. 2a-2c show schematically a screen of an exemplary video conferencing device, which may be part of a conference system according to the present invention, during a vote cast by an online participant.

### DETAILED DESCRIPTION

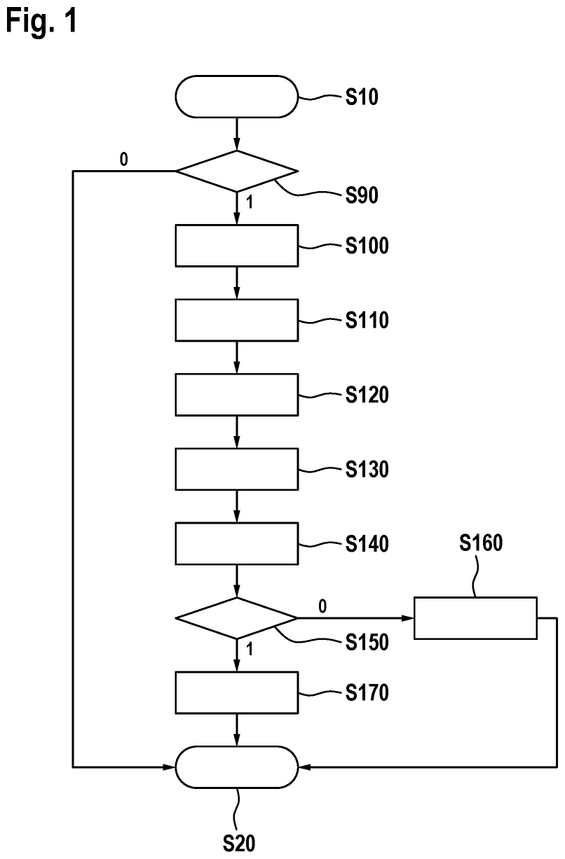

FIG. 1 shows a flow chart illustrating an example of a method according to the present invention. In particular, the flowchart describes an example as to how the vote of an online participant attending a meeting/conference is verified, to ensure that only people who are eligible to vote are considered in the voting. The participant attends remotely, i.e. not using the conference system with its delegate units, but using a first conferencing unit in form of a video conferencing device like a smart phone or personal computer.

After starting the process in step S10, the online participant intending to vote via the first conferencing unit must decide in an optional step 90 whether to agree to image capturing to verify online voting. If the online participant does not agree (0), the process is finished. If the online participant agrees (1), a camera of the first conferencing unit pointed at the online participant is enabled in step S100. The camera may be enabled at the opening of the voting or already when the presence of each participant is verified in the beginning of a meeting.

After enabling the camera, the method proceeds to step S110 in which the online participant submits his vote by means of an input into the first conferencing unit. The first conferencing unit may allow for entering a vote via a respective physical or virtual (touch screen) button.

At the moment when the online participant casts the vote and/or a predetermined time thereafter, an image of the online participant is taken in step S120 by the camera, which may, for example, be an internal camera or a webcam connected to the video conferencing device of the online participant.

This image and the recorded vote are subsequently transmitted to a central conferencing system, step S130.

In next step S140, the image of the online participant is verified on the second conferencing unit by means of a reference. For example, the image of the online participant received by the second conferencing unit can be displayed on a screen of the second conferencing unit together with a reference image. Based on the displayed image, the chairperson, for example, can verify the image by comparing it with the reference image. The reference image may be taken in advance of a conference and stored in a database. For example, the reference image may be submitted as part of a registration for the meeting/conference and stored in the database. In terms of smaller meetings, it may be also possible that the chairperson knows the registered participants personally and is able to identify the online participant without the need of a reference image.

Alternatively or in addition, the comparison of the image of the online participant with the reference image can be performed automatically by the conference system, for example, by using a suitable image processing algorithm. In this case, only the comparison result may be displayed on the second conferencing unit.

If the received image of the online participant matches the reference (path 1 in step S150), the vote of the online participant is counted in step 170. In this context, the second conferencing unit may, e.g., issue a release for counting the received vote based on the match between the received image and the reference image. The release can be automatic or in response to an input from the chairperson. When the second conferencing unit releases the vote, it may be processed and counted in the conference system.

However, if the received image does not match the reference (path 0 in step S150), the vote of the online participant is discarded in step 160. In this case, the second conferencing unit may issue a warning on its screen to inform the chairperson of the failed match of the received image with the reference image. The online participant's vote may then be discarded automatically or in response to an input from the chairperson.

In an embodiment, the matching of the image and the reference is performed automatically by the conference system, e.g. by way of so-called machine learning. However, even then it may be advantageous to not proceed further automatically with counting or discarding the vote, but to let the matching result be confirmed by a human (e.g. chairperson) in order to guarantee that valid votes are not discarded by error, or invalid votes are counted by error.

After that, the procedure is completed in step S20.

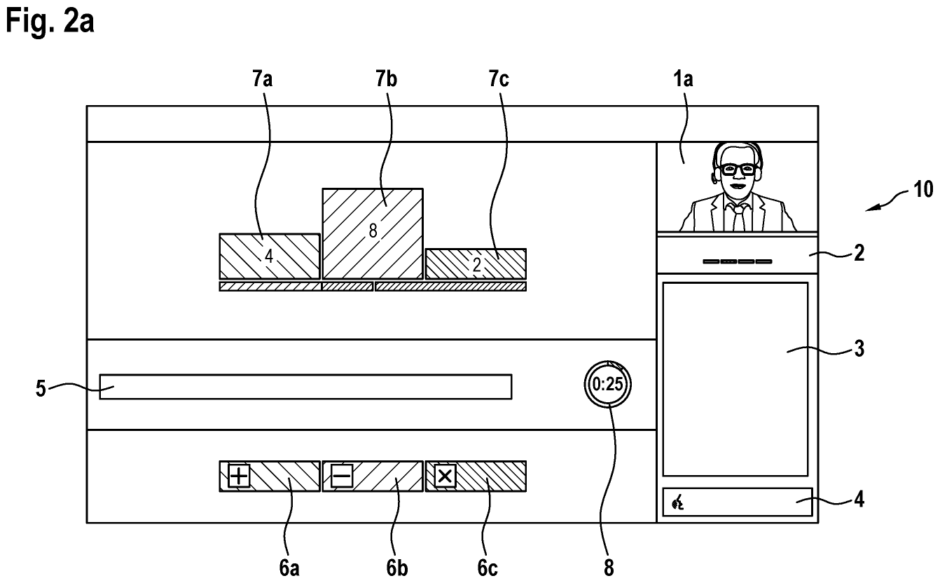

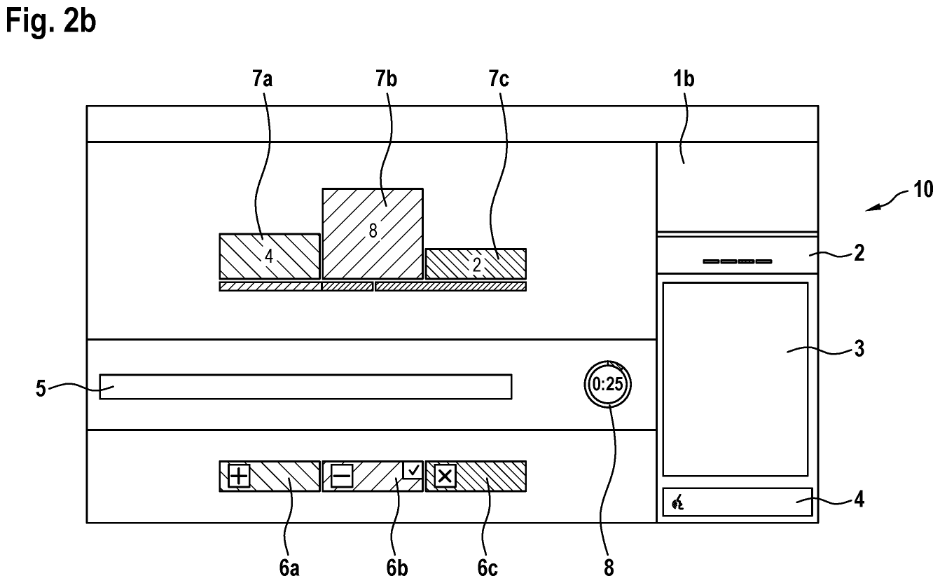

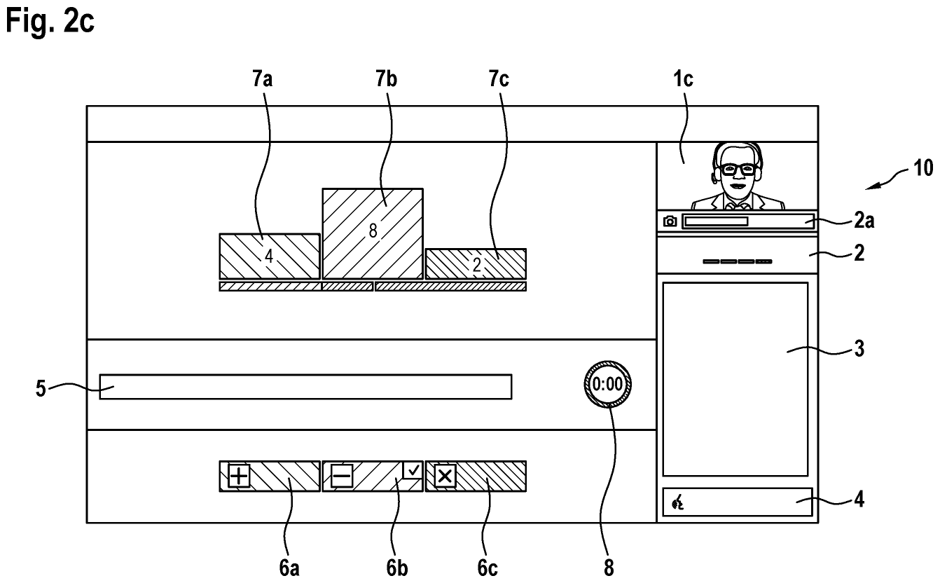

FIGS. 2a-2c show schematically a screen of an exemplary video conferencing device, which may be part of a conference system according to the present invention, during a vote cast by an online participant.

The image shown on the screen 10 in FIG. 2a may be displayed immediately after a camera (not depicted) pointed at the online participant has been enabled. On the right-hand side, the screen image comprises a life camera image la of the online participant and an information panel 2 below the camera image 1a, on which a status of the voting process is depicted. In FIG. 2a, for example, information field 2 can include information that prompts the online participant to cast his vote.

Furthermore, there is a list of votes 3 to be conducted during the meeting and a button 4 for requests to speak on the right side of the screen. In the list of votes, the topics of each vote can be displayed in short form and the topic of the current vote can be highlighted.

On the left side of the list of votes 3 a time period 8 (0:25) is displayed informing the online participant about a remaining time for the current voting.

A topic 5 of the current vote is displayed in the center of the screen 10. The topic 5 may be taken from the list of votes 3 and depicted in more detail in the center of the screen 10.

Below the topic 5 three voting buttons 6a-6c are arranged for inputting a vote into the video conferencing device. Button 6a includes a “+”, which can be used to cast a vote yes, button 6b includes a “−”, which can be used to cast a vote no, and button 6c includes an “x”, which can be used to cast a vote abstain.

Above the displayed topic 5 the current status of the voting is shown. The left bar 7a shows the number of votes in favor, the bar 7b shows the number of votes against and the right bar 7c shows the number of abstentions.

FIG. 2b shows the image on the screen 10 when the online participant has cast his vote. In the example shown, the online participant voted “No”, indicated by the small check mark on button 6b. When the vote has been casted, an image or photo of the online participant has been taken and the camera may again be deactivated, so that the area 1b, on which the life camera image of the online participant was shown in FIG. 2a, is blank. Additionally, the information field 2 may include a message that the vote has been cast.

FIG. 2c shows the image on the screen 10 when the voting is closed. At this time, after the time period 8 has elapsed (0:00), the captured image 1c of the online participant is displayed on the screen 10 along with his vote indicated by the tick in the button 6b. Additionally, in field 2a below the captured image 1c, information about the vote cast may be displayed together with the time of voting. Furthermore, the information field 2 may include a message that the current voting has been completed, and the result of the voting can be inferred from the height of the bars 7a-7c.

To verify the vote of the online participant, the captured image 1c together with the information given in field 2a may be combined in an electronic file and sent to a second conferencing unit in form of a delegate unit of a chairperson of the meeting. In an embodiment, a reference image is shown together with the participant's image on a display of the second conferencing unit. The chairperson may, for example, compare the captured image of the online participant with the reference image to ensure that the person casting the vote is identical to the registered participant of the meeting. If this is the case, the vote casted by the online participant is counted, if not the vote is dismissed.

Providing the captured image 1c together with the information given in field 2a for verification enables a documentation of a vote submitted online along with a visual identification of the participant casting the vote via a video conferencing device. This allows to identify if the person who casts the vote is actually the participant having permission to vote.

1. A method for conducting a voting using a conference system, the conference system including at least a first conferencing unit having a camera and a screen (10), and a second conferencing unit having a screen, the method comprising the steps:
receiving of a vote (6b) by means of an input (6a-6c) into the first conferencing unit;
recording the vote (6b) by the first conferencing unit and capturing an image (1c) by the camera;
sending the vote (6b) and the image (1c) to a second conferencing unit;
verifying the content of image (1c) on the second conferencing unit by means of a reference;
counting the vote (6b) if the image (1c) matches the reference; and
discarding the vote (6b) if the image does not match the reference.

2. The method according to claim 1, comprising
sending a trigger signal from the second conferencing unit to the first conferencing unit,
enabling the camera by the first conferencing unit when the trigger signal is received.

3. The method according to claim 2, comprising:
C transmitting a life camera image to the second conferencing unit when the camera is enabled, until the image is captured.

4. The method according to claim 1, wherein the image (1c) is captured at the moment when the vote is received by the first conferencing unit, and/or a predetermined time after the vote is received by the first conferencing unit.

5. The method according to claim 1, wherein the reference is a reference image of an online participant taken in advance of a conference and stored in a database.

6. The method according to claim 1, wherein the image (1c) and the vote (6b) are stored together in an electronic file.

7. A conference system for conducting a voting comprising at least a first conferencing unit having a camera and a screen, and a second conferencing unit having a screen (10), wherein
the conference system is configured to execute the method according to claim 1.

8. (canceled)

9. A non-transitory, computer-readable medium containing instructions that when executed by the computer cause the computer conduct a voting via a conference system, where the conference system includes at least a first conferencing unit having a camera and a screen (10), and a second conferencing unit having a screen, by:
receiving of a vote (6b) by means of an input (6a-6c) into the first conferencing unit;
recording the vote (6b) by the first conferencing unit and capturing an image (1c) by the camera;
sending the vote (6b) and the image (1c) to a second conferencing unit;
verifying the content of image (1c) on the second conferencing unit by means of a reference;
counting the vote (6b) if the image (1c) matches the reference; and
discarding the vote (6b) if the image does not match the reference.
